(19) United States
(12) Patent Application Publication
(10) Pub. No.: US 2026/0299986 A1
(43) Pub. Date: Oct. 1, 2026

(54) VIRTUAL SYSTEMS on CHIP

(71) Applicant: Silicon Laboratories Inc., Austin, TX (US)

(72) Inventors: Paul Zavalney, Austin, TX (US); Joshua Norem, Austin, TX (US); Mark Johnson, Austin, TX (US); Marius Grannaes, Hosle (NO); Adrianus Bink, Fjellstrand (NO)

(21) Appl. No.: 19/091,218

(22) Filed: Mar. 26, 2025

(51) Int. Cl. G06F 9/455

(52) U.S. Cl. CPC G06F 9/45558

(57) ABSTRACT

A system and method to isolate components within a System on Chip to form a plurality of virtual System on Chips (VSoCs) is disclosed. A bus management protection unit is disposed between each initiator and the fabric and is used to add the identity of the VSoC as an attribute of the transaction. Protection units are disposed in the path of every target to compare the VSoC of the target to the VSoC that was transmitted as an attribute on the fabric. In this way, specific sectors of memory and specific peripherals may be allocated to specific VSoCs, and accesses from components that are not in this VSoC will be blocked.

### FIELD

This disclosure describes a system on chip, and more specifically, a system on chip wherein the components have been isolated to form a plurality of virtual systems on chip.

### BACKGROUND

A System on Chip (SoC) commonly has multiple subsystems, where each subsystem may connect to a fabric, which is used to route the address and data busses to the various subsystems. FIG. 1 shows such a SoC device. In this figure, there are several subsystems. These subsystems may include, for example, a processing subsystem, a cryptography processing subsystem, direct memory access (DMA) controllers, network subsystems and others. In this figure, there is a first processing unit (CPU0) 10 and a second processing unit (CPU1) 11. These processing units may be any suitable component, such as a microprocessor, embedded processor, an application specific circuit, a programmable circuit, a microcontroller, or another similar device. In some embodiments, these processing units may be ARM processors, although other types of processors may also be used.

The memory 20 includes both non-volatile memory, which contains the instructions to be executed by the processing units, as well as volatile memory, which may be random access memory (RAM), dynamic random access memory (DRAM) or another type of memory.

Additionally, there may be a DMA controller 40, which may include one or more independently programmable channels. For example, the DMA controller 40 may have two or more channels, which may be used to transfer data from one region of memory 20 to another.

The System on Chip may also include a network interface 30, which may support one or more networks, which may include wireless networks. The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. The network interface is in communication with the memory 20 so as to transmit packets from and receive packets into the memory 20.

The System on Chip may also include a cryptography processor 50, which is used to encode and decode encrypted packets received over the network interface 30.

Additionally, in some embodiments, there may be a Secure Element 90, which is an isolated on-silicon subsystem with the purpose of running high security operations and is considered to be trustworthy.

Finally, there may be a plurality of peripherals 60. These peripherals 60 may include, for example, timers, UART controllers, I²C controllers, clock generators, and others

Additionally, there may be other subsystems that are not shown here, such as a hardware accelerator for neural networks, a graphic accelerator and others.

As noted above, a fabric 70 is used to connect all of these subsystems. The fabric 70 may include different channels, such as an address channel, a read data channel, and a write data channel. Each channel may include attributes, wherein the attributes are used to convey metadata associated with the transaction. For example, whether the transaction is secure or not may be indicated by an attribute bit.

Note that in this System on Chip, there are a plurality of initiators, which are defined as components or subsystems that are configured to serve as the initiators of transactions on the fabric 70. These initiators include the processing units, the DMA controller 40, the cryptography subsystem 50 and the network interface 30. Further, almost all of the components in the system may also be the target of transactions. FIG. 2 shows the system on chip of FIG. 1 separated in accordance with the role of each component. Those listed along the top row of the diagram are initiators 80, while those under this top row are targets 85. The initiators 80 include the two processing units, the various channels of the DMA controller 40, the network interface 30 and the cryptography subsystem 50. The targets in this figure include 8 sectors of non-volatile memory that contain instructions, labeled RRAM0-RRAM7, 8 sectors of volatile memory, labeled DMEM0-DMEM7, and 8 peripherals 60, labeled Periph0-Periph7. Note that there may be more or fewer sectors of memory and more or fewer peripherals 60. FIG. 2 merely illustrates the different types of targets 85 that may exist. Note that certain components may have both functions. For example, the DMA controller 40 is able to initiate transactions to move data from one region to another, thus defining it as an initiator 80. However, the DMA controller 40 also includes registers that must be configured by one of the processing units, thus also defining it as a target 85.

However, note that, in this configuration, each initiator 80 is able to perform a transaction with any target 85. Thus, corruption of the code in one subsystem has the possibility of corrupting other portions of the system on chip. As an example, if the software stack associated with the network interface 30 is compromised, other portions of the SoC may be impacted.

Therefore, it would be beneficial if there were a system and method that allowed the System on Chip to be partitioned into different virtual Systems on Chip, where each initiator 80 is only allowed access to a predefined subset of all of the targets 85. Further, it would be advantageous if this system and method were easily controlled by software.

### SUMMARY

A system and method to isolate components within a System on Chip to form a plurality of virtual System on Chips (VSoCs) is disclosed. A bus management protection unit is disposed between each initiator and the fabric and is used to add the identity of the VSoC as an attribute of the transaction. Protection units are disposed in the path of every target to compare the VSoC of the target to the VSoC that was transmitted as an attribute on the fabric. In this way, specific sectors of memory and specific peripherals may be allocated to specific VSoCs, and accesses from components that are not in this VSoC will be blocked.

According to one embodiment, a System on Chip (SoC) is disclosed. The SoC comprises a plurality of initiators, wherein each initiator of the plurality of initiators is configured to initiate a transaction; a plurality of targets; and a fabric, connecting the plurality of initiators and targets; wherein each of the plurality of initiators is assigned to a virtual system on chip (VSoC) and the assigned VSoC is included as an attribute when the initiator performs a transaction. In some embodiments, each of the plurality of targets is assigned to one or more VSoCs. In certain embodiments, the transaction is directed toward a target and if the attribute does not match one of the one or more VSoCs that the target is assigned to, the transaction is blocked. In some embodiments, the SoC comprises a plurality of bus management protection units (BMPUs), each disposed between a respective initiator and the fabric, wherein the VSoC of the initiator is stored in the BMPU. In certain embodiments, each initiator and target is also assigned a security state, such that any transaction from an unsecure initiator to a secure target is blocked; and wherein the security state of the initiator is stored in the BMPU. In some embodiments, one or more of the plurality of targets comprises a memory, and the SoC comprises a memory sector protection unit (MSPU), wherein the MSPU comprises a plurality of writable fields, each writable field associated with a sector of the memory, wherein each writable field comprises a mask for each of the VSoCs, such that if the mask associated with a VSoC in a writable field is set to a first value, the sector of the memory associated with that writable field is part of that VSoC. In certain embodiments, each of the plurality of writable fields comprises a lock sector bit, such that if the lock sector bit associated with a writable field is set to a first value, the masks in that writable field cannot be modified. In certain embodiments, the MSPU comprises a lock VSoC bit, such that if the lock VSoC bit associated with a VSoC is set to a first value, the masks in all of the writable fields associated with that VSoC cannot be modified. In some embodiments, the SoC comprises a peripheral protection unit (PPU), wherein the PPU comprises a plurality of writable fields, each writable field associated with a peripheral device, wherein each writable field comprises a mask for each of the VSoCs, such that if the mask associated with a VSoC in a writable field is set to a first value, the peripheral device associated with that writable field is part of that VSoC. In some embodiments, one of the plurality of targets comprises a protection aware peripheral (PAP), wherein the PAP comprises a plurality of writable fields, each writable field associated with a register or bits of the register within the PAP, wherein each writable field comprises a mask for each of the VSoCs, such that if the mask associated with a VSoC in a writable field is set to a first value, the register or bits of the register within the PAP associated with that writable field are part of that VSoC. In some embodiments, a component within the SoC is both an initiator and a target, and the component is assigned a VSoC as an initiator and one or more VSoCs as a target.

According to another embodiment, a method of creating virtual Systems on Chip (VSoCs) within a system on Chip (SOC) is disclosed, wherein the SoC comprises a plurality of initiators and targets connected by a fabric. The method comprises assigning each initiator to one VSoC, wherein each initiator of the plurality of initiators is configured to initiate a transaction on the fabric; and using a processing unit to assign each target to one or more VSoCs; wherein transactions by an initiator to a target are accompanied on the fabric by an attribute that identifies the one VSoC assigned to the initiator; such that accesses from an initiator having a VSoC that is not one of the one or more VSoCs assigned to the target are blocked. In some embodiments, a bus management protection unit (BMPU) is used to store the VSoC of each initiator. In certain embodiments, the processing unit is used to assign the one VSoC of at least one initiator. In some embodiments, one of the targets comprises a memory having a plurality of sectors, wherein a memory sector protection unit (MSPU) is used to store the one or more VSoCs assigned to each sector in the memory, and wherein the processing unit assigns a VSoC to a sector by writing a value to a mask associated with that VSoC in a writable field associated with the sector in the MSPU. In certain embodiments, the processing unit locks the writable field after writing the value to prevent changes to the sector. In certain embodiments, after the processing unit writes values to the masks in all of the writable fields in the MSPU associated with the VSoC, the processing unit locks the values of the masks associated with that VSoC to prevent changes to the VSoC. In some embodiments, one or more of the targets comprises peripheral devices, wherein a peripheral protection unit (PPU) is used to store the one or more VSoCs assigned to each peripheral device, and wherein the processing unit assigns a VSoC to a peripheral device by writing a value to a mask associated with the VSoC in a writable field. In certain embodiments, the processing unit locks the writable field after writing the value to prevent changes to the peripheral device. In some embodiments, one or more of the targets comprises a protection aware peripheral (PAP), wherein the PAP comprises a plurality of writable fields, each writable field associated with a register or bits of the register within the PAP, wherein each writable field comprises a mask for each of the VSoCs, and wherein the processing unit assigns a VSoC to a register or bits of the register by writing a value to a mask associated with the VSoC in a writable field associated with the register or bits of the register.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of the internal architecture of a System on Chip (SoC) according to the prior art;

FIG. 2 is a block diagram of the classification of the SoC of FIG. 1 according to initiator and target;

FIG. 3 shows a block diagram that illustrates the use of virtual System on Chips (VSoCs) according to one embodiment;

FIG. 4 is a block diagram of the SoC that may be used to create the VSoCs according to one embodiment;

FIG. 5 shows a block diagram of a Protection Aware peripheral according to one embodiment;

FIG. 6 shows a block diagram that illustrates the use of secure states and virtual System on Chips (VSoCs) according to one embodiment;

FIG. 7 is a block diagram of the SoC that may be used to create the VSoCs and secure states according to one embodiment; and

FIG. 8 shows a block diagram of a Protection Aware peripheral that supports secure states according to one embodiment.

### DETAILED DESCRIPTION

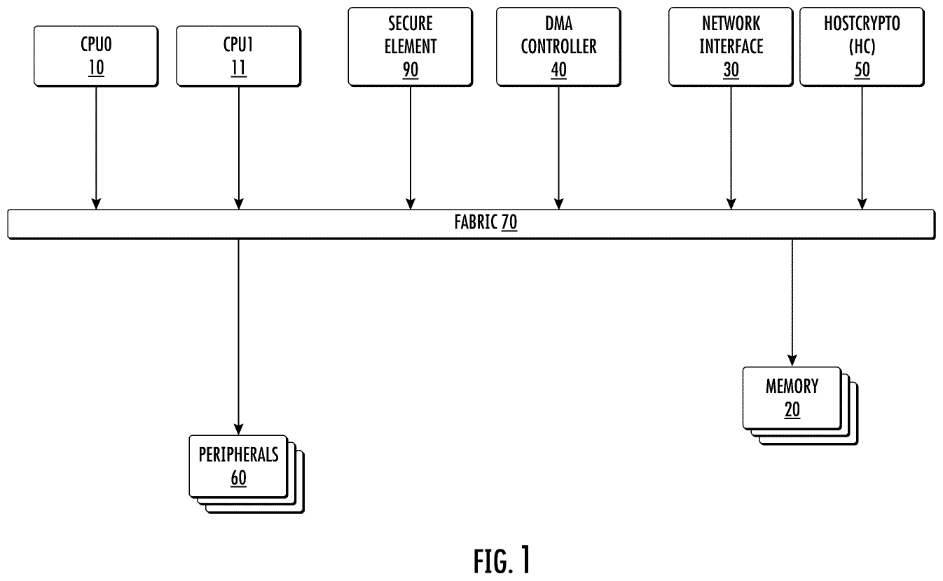

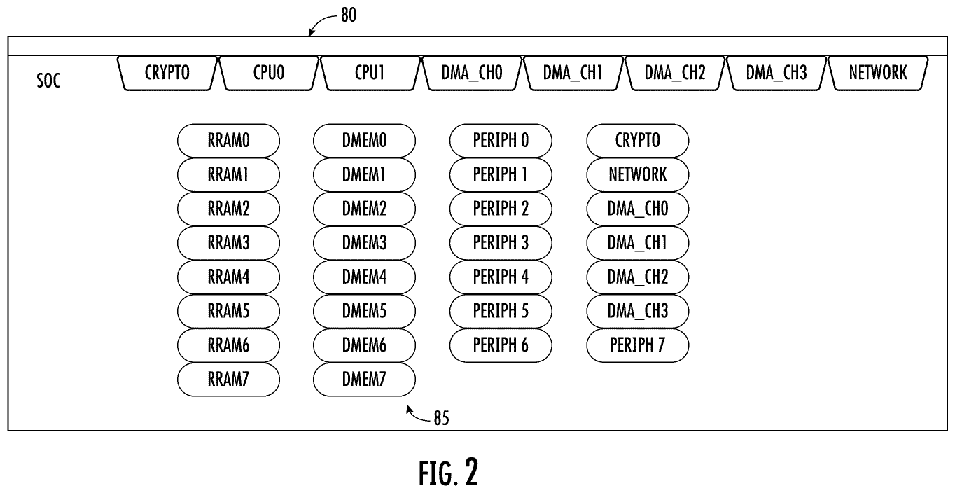

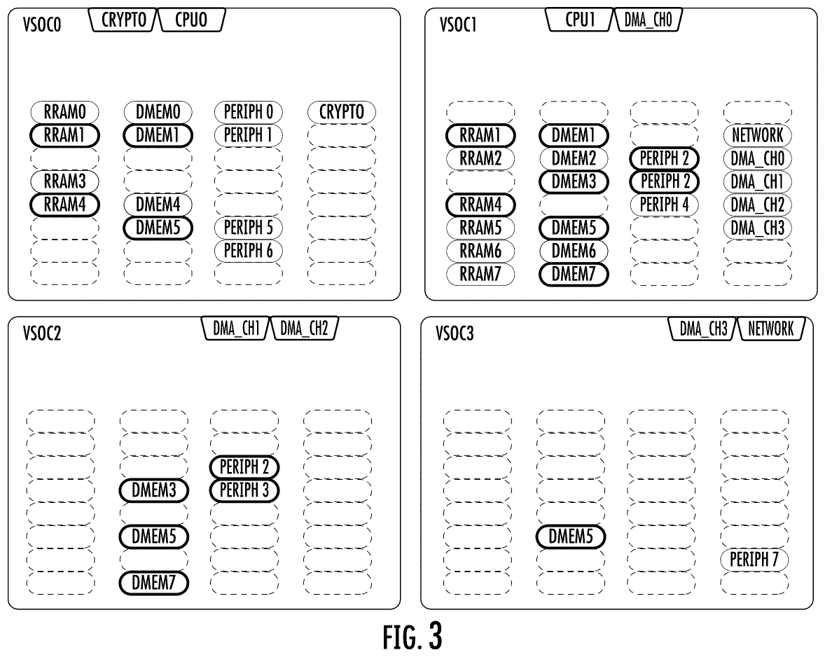

FIG. 3 shows a block diagram of the partitioning of the Soc of FIGS. 1 and 2 into a plurality of Virtual System on Chips (VSoCs). In this figure, the initiators 80 have each been assigned to exactly one VSoC, such as VSoC0, VSoC1, VSoC2 or VSoC3. Note that more than one initiator 80 may be assigned to a given VSoC, but each initiator 80 may only be part of one VSoC. Further, a subset of the targets 85 are also assigned to each VSoC. Targets 85 may be assigned exclusively to one VSoC, or may be shared among 2 or more VSoCs. For example, all of the sectors of nonvolatile memory (RRAM0-RRAM8) are assigned to at least one of the two VSoCs that include processing units. These sectors are not part of VSoC2 or VSOC3. RRAM0 and RRAM3 are assigned exclusively to VSoC0, while RRAM2, RRAM5-RRAM7 are assigned exclusively to VSoC1. Note that RRAM1 and RRAM4 are assigned to both VSoCs. In this figure, shared targets are shown in bold.

FIG. 3 may represent a system where VSoC0 is executing a safety critical application while VSoC1 is executing the wireless stack and the bulk of the user application. Further, in this example, the isolation is limiting the access of the network interface 30 to a subset of what VSoC1 has access to. Finally, some DMA channels are provided with their own special view of the system that allows them to facilitate communication between VSoC0 and VSoC1 while not exposing the bulk of components in these VSoCs.

These virtual SoCs create isolation between the various initiators 80 and targets 85. Thus, when an initiator 80 attempts to access a target 85 that is not assigned to the same VSoC as the initiator, the access will be blocked and an error may be generated.

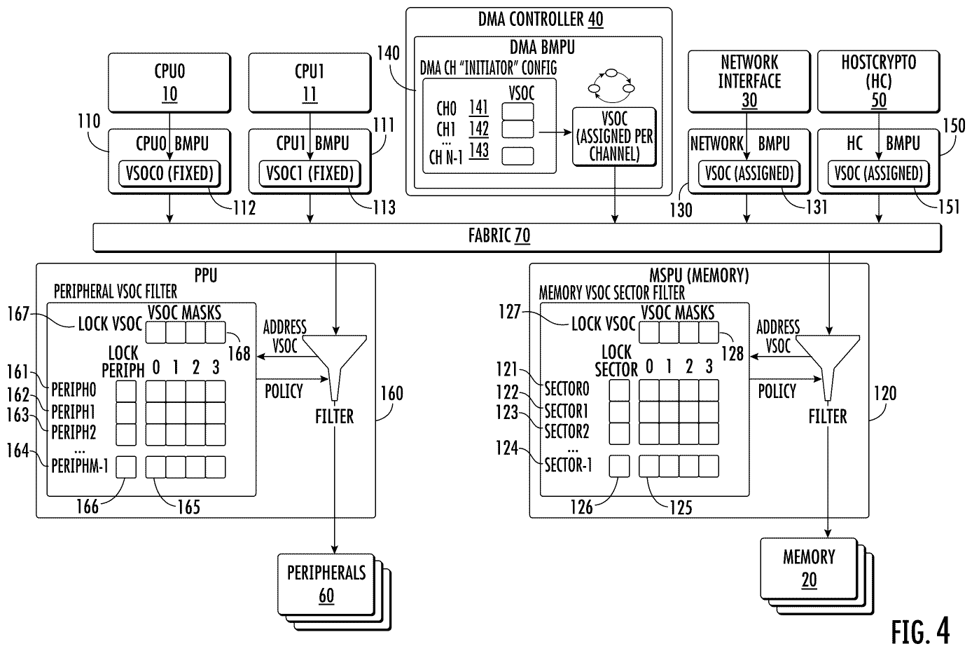

FIG. 4 shows a block diagram that achieves this isolation. First, each initiator has an associated bus manager protection unit (BMPU). Each bus manager protection unit is a circuit that comprises the registers and combinational logic needed to perform the functions described herein. Each BMPU includes a field that, in some embodiments, is writable with different values. The output from the BPMU is in communication with the fabric 70. The bus manager protection unit is responsible for assigning the VSoC of the initiator to any transaction that the initiator performs using the fabric 70. Specifically, the first processing unit 10 has an associated first CPU BMPU 110. In some embodiments, this first CPU BMPU 110 has a fixed VSoC value 112, such as 0. In another words, any transaction initiated by the first processing unit 10 will be accompanied by an attribute that indicates that this transaction is associated with VSoC0. Similarly, the second processing unit 11 has an associated second CPU BMPU 111. The second CPU BMPU 111 also has a VSoC value 113, which may be a fixed value, such as 1. In this way, any transaction initiated by the second processing unit 11 will be accompanied by an attribute that indicates that this transaction is associated with VSoC1. In other embodiments, the VSoC value 113 in the second CPU BMPU 111 may be programmable. In this way, virtual SoC operation may be disabled by assigning the second processing unit 11 to the same VSoC as the first processing unit 10. Note that the SoC is not limited to two processing units. Any number of processing units may be used. Further, in some embodiments, each processing unit may be part of a different VSoC, while in other embodiments, two or more processing units may be part of the same VSoC. The network interface 30 may also have a network BMPU 130, which may include a programmable register 131 for assigning the associated VSoC. Likewise, the cryptography subsystem 50 may include a crypto BMPU 150, which also includes a programmable register 151 for assigning the associated VSoC. Further, the DMA controller 40 may also have a multi-channel bus manager protection unit, referred to as the DMA BMPU 140. However, unlike the other bus manager protection units, the DMA BMPU 140 may have a finer level of granularity. Specifically, each DMA channel in the DMA controller 40 may be independently assigned to a particular VSoC. Thus, unlike the other BMPUs, the DMA BMPU 140 may have multiple channels and may include multiple registers 141-143, to assign a separate VSoC to each DMA channel. Note that if there is only one DMA channel, the DMA BMPU 140 may have only one channel and be identical to those used for the network interface 30 or cryptography subsystem 50.

By incorporating a BMPU for each initiator, the value of the VSoC for each transaction may be made available as an attribute on the fabric 70. To make use of this information, a protection unit is incorporated in the path of each target 85. Each protection unit (PU) is an electronic circuit that includes the registers and combinational logic needed to perform the functions described herein. Each protection unit includes a plurality of writable fields that allow one or more VSoCs to be assigned to each of the targets 85. The protection unit compares the address transmitted over the fabric 70 to determine what target the transaction is intended for. Having determined the intended target based on the address, the protection unit then compares VSoC value transmitted as an attribute over the fabric 70 to each of the assigned VSoCs of the intended target 85. If there is a match, the transaction may proceed. If the transmitted VSoC does not match any of the assigned VSoCs, the transaction is blocked. Specifically, if the transaction is blocked, a read operation will return data of all zeros, and a write operation will be ignored. In certain embodiments, an error may be generated.

FIG. 4 shows a Memory Sector Protection Unit (MSPU) 120. The MSPU 120 includes a plurality of writable fields 121-124. Note that there is no limitations on the number of writable fields that may exist within the MSPU 120. Each writable field is associated with a specific sector of the memory 20. For example, in certain embodiments, a sector may be 16 Kbytes, although other sizes may be used. The MSPU 120 uses the address transmitted on the fabric 70 to determine the intended sector. This may be accomplished using an address filter. Each sector is associated with one of these writable fields 121-124. Each writable field includes a mask 125 associated with each VSoC. If the mask 125 associated with a VSoC is set to a first value, it indicates that the sector associated with this writable field is part of that VSoC. If that mask 125 associated with that VSoC is set to a second value, it indicates that the sector associated with this writable field is not part of that VSoC. By including a mask 125 for each VSoC in the writable field, it allows a sector to be accessible by any number of VSoCs, depending on the values written to the masks 125 in the writable field. For example, referring to FIG. 3, the writable field for RRAM0 will have the mask associated with VSoC0 set to the first value, and the remaining masks set to the second value. In contrast, the writable field for RRAM1 will have the masks 125 associated with VSoC0 and VSoC1 set to the first value and the remaining masks set to the second value. Further, the writable field associated with DMEM5 will have all masks 125 set to the first value.

In some embodiments, each writable field 121-124 may also include a Lock Sector bit 126. In some embodiments, the Lock Sector bit 126 may be set by any of the initiators 80. In other embodiments, this Lock Sector bit 126 may only be set by an initiator in VSoC0. When the Lock Sector bit 126 associated with a writable field is set to the first value, the masks 125 in that corresponding writable field can no longer be modified. When set to the second value, the masks 125 in the writable field are writable. In this way, if a VSoC wishes to have exclusive access to a memory sector, it may set its corresponding mask 125 and then set the Lock Sector bit 126 associated with that memory sector to the first value, to ensure that no other VSoCs can attempt to assign this memory sector. This may be used when one of the processing units wants to have exclusive access to a memory sector. For example, with respect to RRAM0 (see FIG. 3), the first processing unit 10 may set the mask 125 associated with VSoC0 in the writable field associated with RRAM0 to the first value with the remaining masks 125 in that writable field set to the second value. The first processing unit 10 may then set the Lock Sector bit 126 associated with RRAM0 to the first value to ensure that no other VSoCs can access RRAM0.

Further, the MSPU 120 may also include a Lock VSoC field 127 that includes a set of Lock VSOC masks 128. In one embodiment, when a Lock VSoC mask 128 is set to a first value, all of the masks 125 associated with that VSoC in all of the writable fields 121-124 in the MSPU can no longer be modified. For example, if the Lock VSoC mask 128 associated with VSoC0 is set to the first value, all of the masks 125 associated with VSoC0 can no longer be modified. When the Lock VSoC mask 128 is set to a second value, all of the masks 125 associated with that VSoC in all of the writable fields 121-124 in the MSPU remain writable. This may be used to ensure that an initiator in a different VSoC does not change the masks 125 associated with this VSoC. As an example, the first processing unit 10 may set the masks 125 associated with VSoC0 for fields the associated with RRAM0-RRAM1, RRAM3-RRAM4, DMEM0-DMEM1 and DMEM4-DMEM5 to the first value. It may then set the Lock VSoC mask 128 associated with VSoC0 to the first value, to ensure that these assignments are not changed by another initiator. Further, as noted above, the first processing unit 10 may also set the Lock Sector bit 126 for RRAM0, RRAM3, DMEM0 and DMEM4 to the first value to ensure that the first processing unit 10 retains exclusive access to these sectors.

In another embodiment, the Lock VSoC mask may serve to lock any writable field in which the mask associated with that VSoC is set to the first value. For example, the first processing unit 10 may set or clear the masks 125 associated with VSoC0 in all of the writable fields 121-124 in the MSPU. After this is completed, the first processing unit 10 may then set the Lock VSOC mask 128 associated with VSoC0 to the first value. This will serve to lock any writable fields that have the mask 125 associated with VSoC0 set to the first value. Thus, no other initiators are able to modify these writable fields. However, if the mask 125 associated with VSoC0 is set to the second value, the writable field remains writable for other initiators.

The MSPU 120 also includes an address filter which defines the address range for each sector in memory 20. In operation, when an address is presented on the fabric 70, the MSPU 120 uses the address filter to determine whether this transaction is intended for the memory 20, and if so, which sector of the memory 20. If the address is associated with a memory sector, the MSPU 120 then compares the VSoC being provided as an attribute on the fabric 70 to the writable field associated with this memory sector. If the mask 125 associated with the VSoC being provided as an attribute on the fabric 70 is set to the first value, the transaction is allowed. However, if the mask 125 associated with the VSoC being provided on the fabric 70 is set to the second value, the transaction is blocked. Specifically, if the transaction is blocked, a read operation will return data of all zeros, and a write operation will be ignored. In certain embodiments, an error may be generated.

A similar protection unit, referred to as the Peripheral Protection Unit (PPU) 160, may also be included to protect all of the peripheral devices 60. In this embodiment, the structure of the PPU 160 is similar to that of the MSPU 120. There are writable fields 161-164 associated with each peripheral device 60. Each writable field includes a plurality of masks 165, one for each VSOC. As explained above, when a mask 165 is set to the first value, the peripheral device 60 associated with this writable field is part of the VSoC associated with that mask 165. Further, as described above, there may be Lock Peripheral bits 166 associated with each peripheral device. As explained above, this Lock Peripheral bit 166 may be used to ensure exclusive access to a peripheral device 60. Further, there may be a Lock VSoC field 167 having a plurality of Lock VSOC masks 168. In some embodiments, these Lock VSoC masks 168 may be used to ensure that an assignment made by an initiator in one VSoC cannot be changed by an initiator in another VSoC. In other embodiments, the Lock VSOC masks 168 allow a VSoC to lock any writable field that is part of that VSoC, as described above. Additionally, an address filter is used to denote the address range of each peripheral device.

Further, note that, although not shown, a protection unit (PU) may be disposed between the fabric 70 and the DMA controller 40 and between the fabric 70 and the cryptography subsystem 50, as these components also serve as targets. In certain embodiments, this functionality may be embedded in the bus management protection units.

Note that, using this structure, there may be no changes required to the design of the various hardware components in the SoC. Specifically, the BMPUs are additional components that are located between the initiators 80 and the fabric 70. Thus, no changes are required to the initiators 80. Similarly, the MSPU 120 and PPU 160 are located between the fabric 70 and the targets 85. Thus, again, no changes are required to these targets. However, in some other embodiments, the DMA controller 40 may be modified such that the DMA BMPU 140 is disposed within the DMA controller 40, rather than being a separate component.

Note that while FIG. 4 shows 4 VSoCs, the disclosure is not limited to any particular number of VSoCs. This concepts may be used for 2 VSoCs, or may be expanded to handle an arbitrary number of VSoCs. The MSPU 120 would be modified to include an appropriate number of masks 125 for each writable field. Similarly, the PPU 160 would also be modified to include an appropriate number of masks 165 for each writable field.

Having described the structure of the SoC to create VSoCs, the initialization process will now be defined. In one embodiment, a centralized isolation assignment is performed. Centralized isolation assignment denotes that all of the VSoC assignments are performed by a single entity. In one embodiment, a Secure Element 90 (see FIG. 1) configures all of the BMPUs, MSPUs and PPUs and then sets the Lock VSoC masks, Lock Sector bits and Lock Peripheral bits to the first value to ensure that no other initiator can attempt to modify this configuration. In some embodiments, as described above, the Secure Element 90 is an isolated on-silicon subsystem with the purpose of running high security operations and is considered to be trustworthy. In this embodiment, the Secure Element is a subsystem that includes a specialized processing unit that is able to access all targets regardless of the VSoC mask settings. Thus, the Secure Element 90 is not assigned a VSoC.

In another embodiment, all of the BMPUs, MSPUs and PPUs are configured by the first processing unit 10. It then sets the Lock VSoC masks, Lock Sector bits and Lock Peripheral bits to the first value to ensure that no other initiator can attempt to modify this configuration. Thus, in the centralized isolation assignment, all of the BMPUs, MSPUs and PPUs are initialized using a processing unit, which may be the first processing unit 10, or the Secure Element 90.

In a third embodiment, a distributed isolation assignment is performed. In this embodiment, the first processing unit 10 sets all of the masks associated with VSoC0. It then sets the Lock VSoC bit associated with VSoC0 in each of the protection units to the first value to ensure that none of the assignments for VSoC0 are modified. The first processing unit 10 may also set the Lock Sector or Lock Peripheral bit for any component that it wants exclusive access to. Once the first processing unit 10 completes the configuration of its VSoC, it may then allow the second processing unit 11 to perform the configuration of VSoC1. This may be repeated for each processing unit in the SoC.

In some embodiments, the VSoC configuration described above is performed at boot time and is not changed again. In other words, in these embodiments, the VSoC configuration is static after the initialization is completed.

In some embodiments, the granularity offered by the peripheral protection unit 160 may not be sufficient. For example, some peripherals may include general purpose input/output (GPIO) pins. For these GPIO pins, it may be advantageous to be able to assign these GPIOs, which are all within the same peripheral device 60, to different VSoCs. In one embodiment, the Peripheral Protection Unit 160 may include finer granularity than simply the individual peripheral device 60. For example, it may allow granularity to the individual register within the peripheral device 60. This is accomplished by refining the address filter within the PPU 160 to detect individual registers, rather than simply peripheral devices.

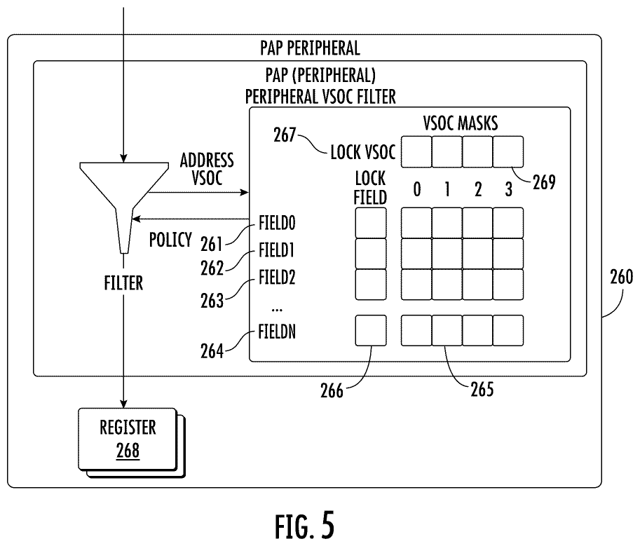

In other embodiments, the peripheral device 60 may be modified to be protection aware. FIG. 5 shows a protection aware peripheral (PAP) 260 according to one embodiment. The PAP 260 includes an address filter, as described above. Within the PAP 260 are one or more writable fields 261-264. In one embodiment, these writable fields may be associated with individual registers 268 within the PAP 260. In other embodiments, these writable fields may offer finer granularity, such as individual bits or groups of bits, within a register 268.

Each writable field includes a plurality of masks 265, one for each VSoC. As explained above, when a mask 265 is set to the first value, the bit or bits within the register 268 associated with this writable field is part of the VSoC associated with that mask 265. Further, as described above, there may be Lock Field bits 266 associated with each field. As explained above, this Lock Field bit 266 may be used to ensure exclusive access to a field within a register 268 in the PAP 260. Further, there may be a Lock VSoC field 267 having a plurality of Lock VSOC masks 269. In some embodiments, these Lock VSOC masks 269 may be used to ensure that the assignment made by an initiator in one VSoC cannot be changed by an initiator in another VSoC. In other embodiments, the Lock VSoC masks 269 allow a VSoC to lock any writable filed that is part of that VSoC, as described above. Note that this embodiment allows granularity to the bit level for the various VSoCs.

Further, in some embodiments, the processing units 10, 11 may support two different security states, referred to as secure state and non-secure state. In some processing units, such as ARM processors, this functionality is referred to as TrustZone. In general, processing units 10, 11 have the ability to execute instructions in both the secure state and non-secure state. Further, other initiators are typically limited being classified as either secure or non-secure. A secure initiator is able to access both secure and non-secure targets; however, a non-secure initiator may only access non-secure targets.

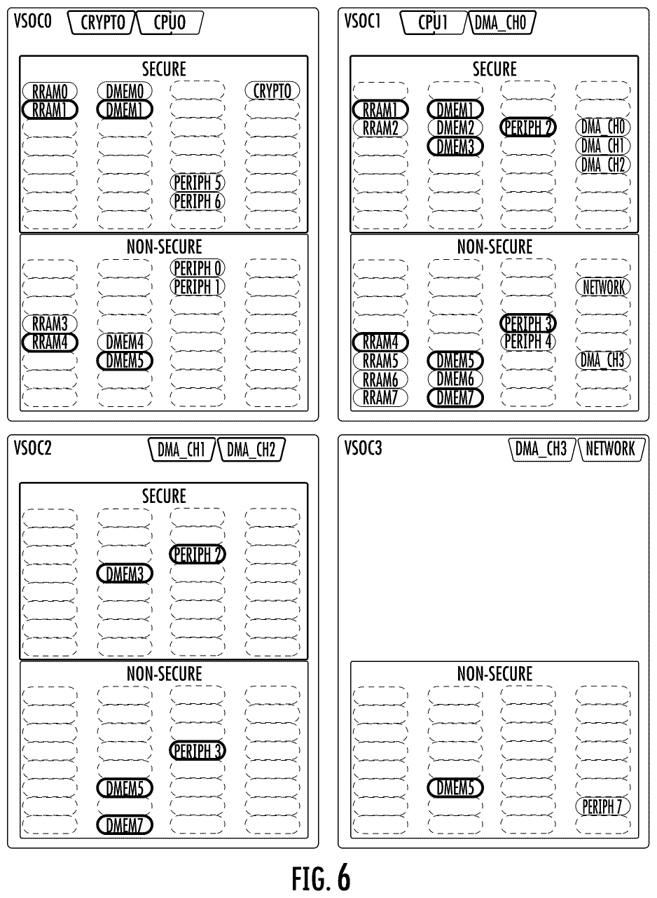

FIG. 6 is another representation of the VSoCs shown in FIG. 3. In this figure, in addition to a VSoC, each initiator and target is also assigned a security state. As explained above, processing units 10, 11 can operate in either state. In this example, the cryptography subsystem 50 and three of the DMA channels (DMA_CH0 through DMA_CH2) have been designated as secure, while the third DMA channel (DMA_CH3) and the network interface 30 are designated as non-secure. Note that the non-secure initiators have been placed in a separate VSoC (VSoC3) that only includes non-secure targets. The other initiators are placed in VSoCs that include both secure and non-secure targets.

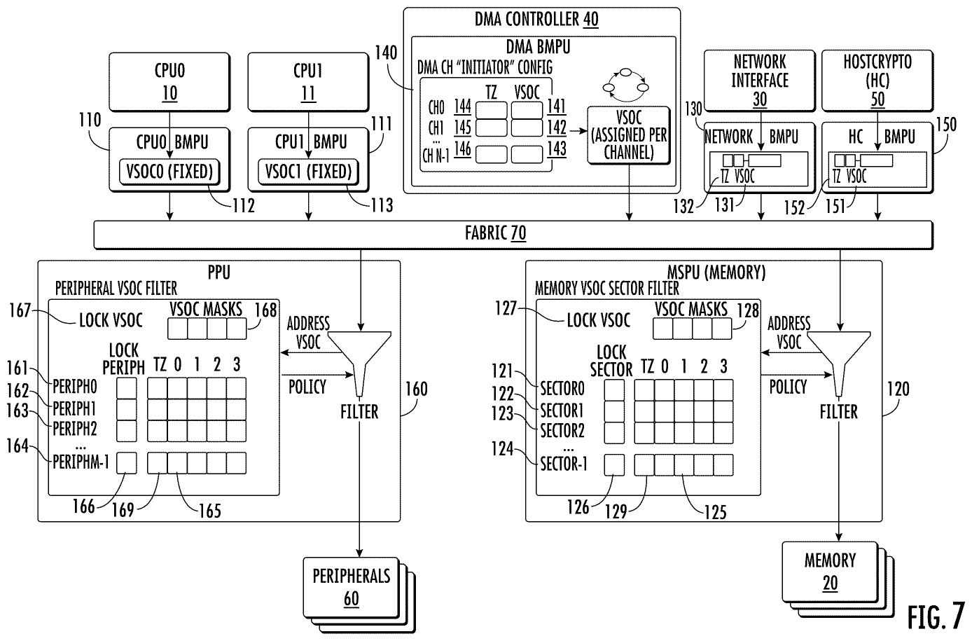

FIG. 7 shows a modification to the BMPUs, MSPUs and the PPUs of FIG. 4 to achieve this level of security. In this figure, each BMPU (except for those associated with the processing units) now includes a TZ flag, which signifies whether that initiator operates in secure mode or non-secure mode. Specifically, the network BMPU 130 now includes a Network TZ flag 132, which indicates whether the network interface 30 is operating in secure state or non-secure state. Thus, when the network interface 30 initiates a transaction on the fabric 70, the attributes associated with that transaction include both the VSoC of the network interface 30 as well as its security assignment. Additionally, a HC TZ flag 152 is added to the crypto BMPU 150. The DMA BMPU 140 includes a plurality of TZ flags 144-146, one for each DMA channel.

In contrast to the BMPUs, the processing units 10, 11 generate the TZ flag automatically. During configuration, certain regions of memory are designated as secure. When the processing unit is executing code in one of these secure regions, the TZ flag will be set automatically by the processing unit. When the processing unit is not executing code in these regions, the TZ flag is not set.

To ensure proper operation, each of the protection units is also modified to include TZ flags. Specifically, the MSPU 120 now includes a TZ flag 129 for each sector. Note that a sector has only one security assignment, regardless of which initiator is accessing it. Therefore, once assigned as secure or non-secure, the sector maintains that security assignment for all VSoCs; it cannot be modified per VSoC. Similarly, the peripheral PU 160 includes a TZ flag 169 for each peripheral. In this way, if a peripheral device is marked as secure, only accesses from secure initiators are permitted. Accesses from non-secure initiators will be blocked. Specifically, if the transaction is blocked, a read operation will return data of all zeros, and a write operation will be ignored. In certain embodiments, an error may be generated.

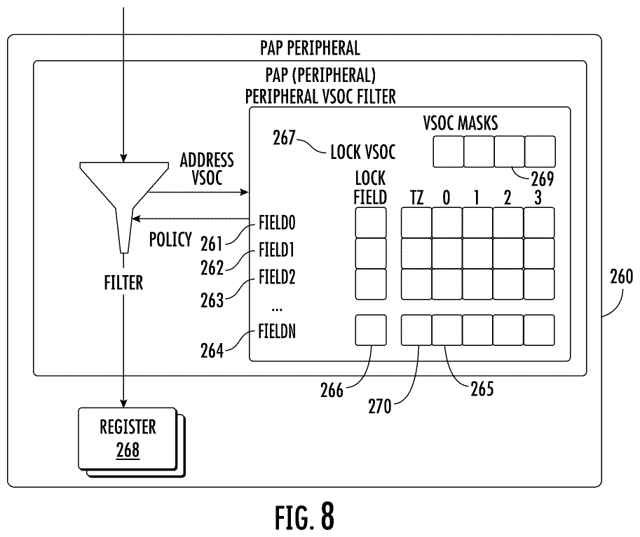

This concept can also be expanded to the protection aware peripheral (PAP) 260, as shown in FIG. 8. For each field, a TZ flag 270 may be added.

The present system and method has many advantages. First, as explained above, the use of separate BMPUs and PUs allows the other components of the SoC to be used without modification. This may simplify the design of SoCs with multiple virtual SoCs. Additionally, the configuration of the various VSoCs is performed during an initialization procedure and need not be modified thereafter. Thus, there is no software performance penalty associated with this approach. Further, if the BMPUs, MSPUs and PPUS are configured during an initialization procedure, the remaining software components may be completely unaware of the Virtual SoCs, thereby reducing the complexity of the software as well.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A System on Chip (SoC), comprising:
a plurality of initiators, wherein each initiator of the plurality of initiators is configured to initiate a transaction;
a plurality of targets; and
a fabric, connecting the plurality of initiators and targets;
wherein each of the plurality of initiators is assigned to a virtual system on chip (VSoC) and the assigned VSOC is included as an attribute when the initiator performs a transaction.

2. The SoC of claim 1, wherein each of the plurality of targets is assigned to one or more VSoCs.

3. The SOC of claim 2, wherein the transaction is directed toward a target and wherein if the attribute does not match one of the one or more VSoCs that the target is assigned to, the transaction is blocked.

4. The SoC of claim 1, further comprising a plurality of bus management protection units (BMPUs), each disposed between a respective initiator and the fabric, wherein the VSoC of the initiator is stored in the BMPU.

5. The SoC of claim 4, wherein each initiator and target is also assigned a security state, such that any transaction from an unsecure initiator to a secure target is blocked; and wherein the security state of the initiator is stored in the BMPU.

6. The SoC of claim 1, wherein one or more of the plurality of targets comprises a memory, and further comprising a memory sector protection unit (MSPU), wherein the MSPU comprises a plurality of writable fields, each writable field associated with a sector of the memory, wherein each writable field comprises a mask for each of the VSoCs, such that if the mask associated with a VSoC in a writable field is set to a first value, the sector of the memory associated with that writable field is part of that VSoC.

7. The SoC of claim 6, wherein each of the plurality of writable fields comprises a lock sector bit, such that if the lock sector bit associated with a writable field is set to a first value, the masks in that writable field cannot be modified.

8. The SoC of claim 6, wherein the MSPU comprises a lock VSoC bit, such that if the lock VSoC bit associated with a VSoC is set to a first value, the masks in all of the writable fields associated with that VSoC cannot be modified.

9. The SoC of claim 1, further comprising a peripheral protection unit (PPU), wherein the PPU comprises a plurality of writable fields, each writable field associated with a peripheral device, wherein each writable field comprises a mask for each of the VSoCs, such that if the mask associated with a VSoC in a writable field is set to a first value, the peripheral device associated with that writable field is part of that VSoC.

10. The SoC of claim 1, wherein one of the plurality of targets comprises a protection aware peripheral (PAP), wherein the PAP comprises a plurality of writable fields, each writable field associated with a register or bits of the register within the PAP, wherein each writable field comprises a mask for each of the VSoCs, such that if the mask associated with a VSoC in a writable field is set to a first value, the register or bits of the register within the PAP associated with that writable field are part of that VSoC.

11. The SOC of claim 1, wherein a component within the SoC is both an initiator and a target, and wherein the component is assigned a VSoC as an initiator and one or more VSoCs as a target.

12. A method of creating virtual Systems on Chip (VSoCs) within a system on Chip (SOC), the SOC comprising a plurality of initiators and targets connected by a fabric, the method comprising:
assigning each initiator to one VSoC, wherein each initiator of the plurality of initiators is configured to initiate a transaction on the fabric; and
using a processing unit to assign each target to one or more VSoCs;
wherein transactions by an initiator to a target are accompanied on the fabric by an attribute that identifies the one VSoC assigned to the initiator;
such that accesses from an initiator having a VSoC that is not one of the one or more VSoCs assigned to the target are blocked.

13. The method of claim 12, wherein a bus management protection unit (BMPU) is used to store the VSoC of each initiator.

14. The method of claim 13, wherein the processing unit is used to assign the one VSoC of at least one initiator.

15. The method of claim 12, wherein one of the targets comprises a memory having a plurality of sectors, wherein a memory sector protection unit (MSPU) is used to store the one or more VSoCs assigned to each sector in the memory, and wherein the processing unit assigns a VSoC to a sector by writing a value to a mask associated with that VSoC in a writable field associated with the sector in the MSPU.

16. The method of claim 15, wherein the processing unit locks the writable field after writing the value to prevent changes to the sector.

17. The method of claim 15, wherein after the processing unit writes values to the masks in all of the writable fields in the MSPU associated with the VSoC, the processing unit locks the values of the masks associated with that VSoC to prevent changes to the VSoC.

18. The method of claim 12, wherein one or more of the targets comprises peripheral devices, wherein a peripheral protection unit (PPU) is used to store the one or more VSoCs assigned to each peripheral device, and wherein the processing unit assigns a VSoC to a peripheral device by writing a value to a mask associated with the VSoC in a writable field.

19. The method of claim 18, wherein the processing unit locks the writable field after writing the value to prevent changes to the peripheral device.

20. The method of claim 12, wherein one or more of the targets comprises a protection aware peripheral (PAP), wherein the PAP comprises a plurality of writable fields, each writable field associated with a register or bits of the register within the PAP, wherein each writable field comprises a mask for each of the VSoCs, and wherein the processing unit assigns a VSoC to a register or bits of the register by writing a value to a mask associated with the VSoC in a writable field associated with the register or bits of the register.
